(19) United States
(12) Patent Application Publication
(10) Pub. No.: US 2011/0315328 A1
(43) Pub. Date: Dec. 29, 2011

(54) GARAGE DOOR SCREEN

(76) Inventor: CHARLES HAZEL, Jeffersonville, IN (US)

(21) Appl. No.: 12/822,166

(22) Filed: Jun. 23, 2010

(51) Int. Cl. E06B 9/60; E06B 9/42

(52) U.S. Cl. 160/313; 160/323.1

(57) ABSTRACT

The present invention relates to a garage door screen assembly for covering a garage opening comprising: a cylindrical enclosure, where said enclosure is positioned above the opening; a tracking assembly on each side of the opening; a retractable screen, where said screen is stored within the enclosure when a retracted position and said screen extends downwardly over the opening when in a released position, where said tracking assembly guides the screen between the retracted position and the released position. In one exemplary embodiment, the screen is spring loaded within the enclosure and may include a handle attached to the screen, where said handle provides a means to move the screen between the retracted position and the released position. In another exemplary embodiment, the screen covers the entire garage opening.

### BACKGROUND OF THE INVENTION

1. Field of Invention

The present invention relates to a garage door screen capable of being stored above a garage door and released over a garage door opening as desired.

2. Description of Related Art

Many homes come equipped with a garage for parking of a vehicle and storage materials. Each garage includes a large door that may open and close to allow the entry and exit of a vehicle parked within a garage. Garage doors may be opened manually or through the use of a garage door opener. The garage doors are usually sectional, self-storing and run along a pair of tracks that allow for the movement of the door from an open to closed position. The typical garage door includes several panels that are hinged together that roll along these tracks guided by rollers. The weight of the door is usually balanced through a spring system that allows for the movement of the door over the tracks.

Many times individuals are working within a garage they may have the garage door in an open position. One drawback to having a garage door in an open position is the influx of insects or other undesirable creatures or objects within the garage door opening. It would be therefore advantageous to have a screen that could cover the garage door opening when the garage door is in an open position. Examples of garage door screens are disclosed in U.S. Pat. No. 5,904,199 which discloses a garage door screen that is defined by a peripheral frame including opposed long and upper members and opposed short-side members. The garage door screen hangs below the bottom edge of the garage door when the door is in an open orientation. Another example of a garage door screen apparatus is disclosed in U.S. Pat. No. 6,415,844 that discloses a garage door screen that is adapted to be securely and removably disposed in a garage doorway. Both of these examples of garage door screens depict screen assemblies that provide for a partial opening of a garage door and a screen apparatus that is used to cover the partial opening.

U.S. Pat. No. 7,086,442 discloses a screen door closure that is integrated with the garage door and includes a plurality of panels where the panels are hingeably coupled to and adjacent to one of the garage door panels. The screen door is engaged with a tracking system similar to the garage door and has a separate set of rollers associated with the screen door to provide for movement of the screen door into a lowered or raised position.

It would be advantageous to have a screen door that provides a covering for a garage door opening where the screen provides for coverage of the entire garage door opening when the garage door is in an open position. Further it would be advantageous to have a screen that is separate from the roller system associated with the garage door.

### SUMMARY OF THE INVENTION

The present invention relates to a garage door screen assembly for covering a garage opening comprising: a cylindrical enclosure, where said enclosure is positioned above the opening; a tracking assembly on each side of the opening; a retractable screen, where said screen is stored within the enclosure when a retracted position and said screen extends downwardly over the opening when in a released position, where said tracking assembly guides the screen between the retracted position and the released position. In one exemplary embodiment, the screen is spring loaded within the enclosure and may include a handle attached to the screen, where said handle provides a means to move the screen between the retracted position and the released position. In another exemplary embodiment, the screen covers the entire garage opening.

### BRIEF DESCRIPTION OF DRAWINGS

FIG. 1A depicts a garage door opening that includes a means for releasing a screen over the garage door opening.

FIG. 1B depicts the deployment of a screen over the garage door opening according to the present invention.

### DETAILED DESCRIPTION

The present invention provides a retractable screen door for a garage door opening that is enclosed in a cylindrical enclosure when not in use. The screen is released vertically and placed over the garage door opening as desired by the user. The screen enables free ventilation of air within the garage but protects the garage from the influx of insects such as mosquitoes and other pests while the garage door is open.

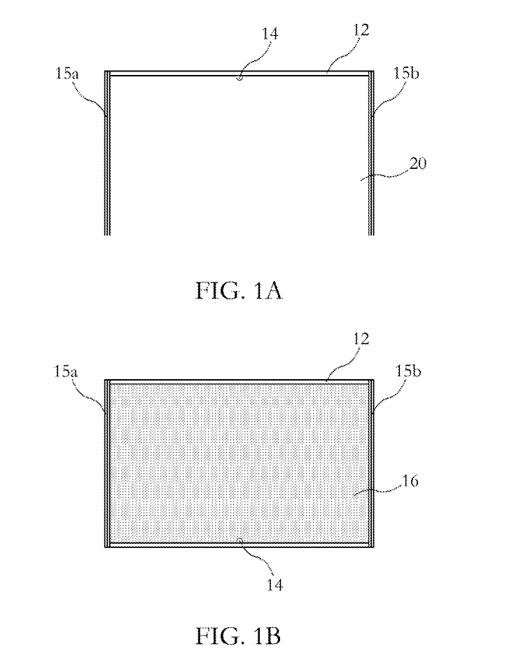

The garage door screen is depicted in FIG. 1A in a retracted position. A Door Opening 20 is shown where a pair of Side Tracking Assemblies 15a, 15b are depicted on each side of the door opening. Above the door opening, a Cylindrical Enclosure 12 is provided which encloses a retractable screen. A handle 14 is visible that hangs downwardly from the Cylindrical Enclosure 12 when the screen is retracted within the cylinder.

The door screen according to the present invention is manually operated and retracts into the Cylindrical Enclosure 12 when not in use. The screen may be released and covers the entire garage opening as depicted in FIG. 1B. A Screen 16 is shown that covers the garage door opening and is placed over the opening by pulling the Handle 14. The Screen 16 is stored in a spring-loaded position and therefore when desired the Screen 16 may be retracted back into the Cylindrical Enclosure 12 to allow for the entry and exit of vehicles, individuals or other materials. The Screen 16 is guided along the Sidetrack Assemblies 15a, 15b and designed to provide a mesh screen covering of the garage door opening.

This retractable screen covering according to the present invention provides the means to prevent the entry of insects or other pests within the garage while the garage door is in an open position. The screen allows for the flow of air through the garage and is retractable into a storage cylinder after use. The screen is maintained in alignment through the use of tracking provided on each side of the garage door. The instant invention has been shown and described in what it considers to be the most practical and preferred embodiments. It is recognized, however, that departures may be made there from within the scope of the invention and that obvious modifications will occur to a person skilled in the art.

What is claimed is:

1. A garage door screen assembly for covering a garage opening comprising:
a. a cylindrical enclosure, where said enclosure is positioned above the opening;
b. a tracking assembly on each side of the opening;
c. a retractable screen, where said screen is stored within the enclosure when a retracted position and said screen extends downwardly over the opening when in a released position, where said tracking assembly guides the screen between the retracted position and the released position.

2. The garage door screen assembly according to claim 1, where said screen is spring loaded within the enclosure.

3. The garage door screen assembly according to claim 1, further including a handle attached to the screen, where said handle provides a means to move the screen between the retracted position and the released position.

4. The garage door screen assembly according to claim 1, where the screen covers the entire garage opening.
